(19) United States
(12) Patent Application Publication
(10) Pub. No.: US 2010/0265056 A1
(43) Pub. Date: Oct. 21, 2010

(54) Vehicle Safety Belt Warning Device

(76) Inventor: Kee Weng Lai, Taipei City (TW)

Correspondence Address: WPAT, PC;INTELLECTUAL PROPERTY ATTORNEYS, 7225 BEVERLY ST., ANNANDALE, VA, 22003, US

(21) Appl. No.: 12/829,659

(22) Filed: Jul. 2, 2010

Related U.S. Application Data
(63) Continuation-in-part of application No. 11/697,778, filed on Apr. 9, 2007.

(51) Int. Cl. B60Q 1/00; G08B 21/00

(52) U.S. Cl. 340/457.1; 340/540

(57) ABSTRACT

A vehicle safety belt warning device which comprises a sensing member and a warning member electrically coupled to the sensing member. The sensing member comprises a magnetic element installed on a first buckle member of the vehicle safety belt buckle set and a magnetically-activated control element installed on a second buckle member of the vehicle safety belt buckle set. When the first buckle member and the second buckle member are not engaged, the warning member gives off a warning signal in the form of sound, light or combination thereof.

### CROSS REFERENCE TO RELATED APPLICATIONS

This application is a continuation in part of applicant's earlier application, Ser. No. 11/697,778, filed Apr. 9, 2007.

### BACKGROUND OF THE INVENTION

1. Field of the Invention

The present invention generally relates to a warning device, especially to a vehicle safety belt warning device.

2. Description of the Prior Art

Many people are killed in car accidents due to failure to use the safety belt. However, it is widely recognized that seat belt systems with which most vehicles presently in use are equipped are often not used. People either find it inconvenient or troublesome to repeatedly fasten and unfasten themselves, or they find them uncomfortable or somewhat restrictive of movement with the safety belt fastened.

Another important cause of failure to use the safety belt is the unawareness of not being buckled up due to distractions such as answering phone calls, talking to other occupants, or being busy putting away food or drinks that were just bought.

Therefore, it is desirable to provide for real-time alarm to bring to the occupant's attention to fasten the safety belt, so as to avoid unnecessary death in a car accident.

### SUMMARY OF THE INVENTION

According to the above, the present invention provides a vehicle safety belt warning device fulfill the requirements of the industry.

It is one object of the present invention to provide a vehicle safety belt warning device which comprises a sensing member and a warning member electrically coupled to the sensing member. The sensing member comprises a magnetic element installed on a first buckle member of the vehicle safety belt buckle set, and a magnetically-activated control element installed on a second buckle member of the vehicle safety belt buckle set. When the first buckle member and the second buckle member are not engaged, the warning member gives off a warning signal in the form of sound, light or combination thereof. When the first and second buckle members are engaged, the magnetically-activated control element senses the magnetic field produced by the magnetic element and switches off the warning member.

It is another object of the invention to provide a vehicle safety belt warning device, the provided warning device comprises a first magnetic element which is installed on the vehicle door; a second magnetic element which is disposed within the interior of the vehicle and in a position corresponding to the first magnetic element; a warning member which is electrically coupled to the second magnetic element; and a power supply member which is electrically coupled to the warning member. Either the first and second magnetic element may be a magnetically-activated control device. When the vehicle door is closed, the magnetically-activated control device senses the magnetic field produced by the magnetic element and activates the warning member to give off a warning signal which may be in the form of sound, light or combination thereof.

### BRIEF DESCRIPTION OF THE DRAWINGS

FIG. 1 is an illustration of a warning device in accordance with an embodiment of the present invention;

FIG. 2 is an illustration of a warning device in accordance with a preferred example of the present invention; and

FIG. 3 is an illustration of how a warning device in accordance with another preferred example of the present invention is used with the vehicle safety belt buckle set;

FIG. 4 is an illustration of a warning device in accordance with yet another preferred example of the present invention; and

FIG. 5A and FIG. 5B illustrate a clipper in accordance with one preferred example of this specification for properly putting a magnetic element onto the accurate position of a buckle member.

### DESCRIPTION OF THE PREFERRED EMBODIMENTS

What probed into the invention is a vehicle safety belt warning device. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

According to the above-mentioned desirability of providing real-time alarm for the vehicle safety belt system, the present invention provides a warning device which may be directly adapted to the conventional vehicle safety belt buckle set which comprises a first buckle member and a second buckle member for engaging with the first buckle member to restrain an occupant in a vehicle for safety purpose.

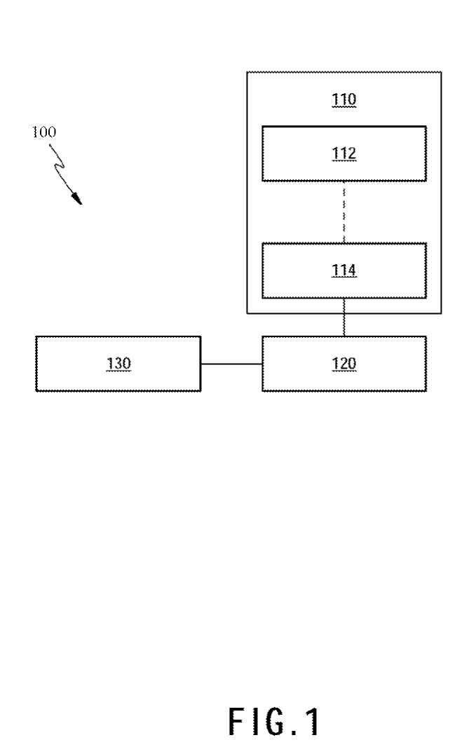

One preferred embodiment according to this specification discloses a vehicle safety belt warning device. Referring to FIG. 1, the provided warning device 100 comprises a sensing member 110 and a warning member 120 electrically coupled to the sensing member 110. The provided warning device 100 may also comprise a power supply member 130, electrically coupled to the warning member 120, for providing power to the provided warning device 100.

The sensing member 110 comprises a magnetic element 112 and a magnetically-activated control element 114 electrically coupled to the warning member 120, wherein when the magnetically-activated control element 114 does not sense the magnetic field produced by the magnetic element 112, the magnetically-activated control element 114 activates the warning member 120 to give off a warning signal which may being the form of sound, light or combination thereof. On the other hand, when the magnetically-activated control element 114 senses the magnetic field produced by the magnetic element 112, the magnetically-activated control element 114 switches off the warning member 120.

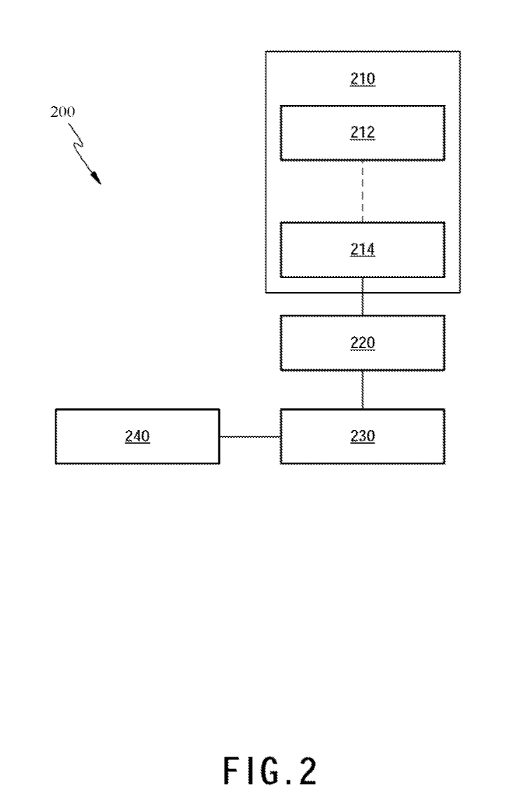

Referring to FIG. 2, in one preferred example of the above embodiment, the provided warning device 200 comprises a sensing member 210 and a warning member 230 electrically coupled to the sensing member 210. The provided warning device 200 may also comprise a power supply member 240, electrically coupled to the warning member 230, for providing power to the provided warning device 200. The sensing member 210 comprises a magnetic element 212 and a magnetically-activated control element 214 electrically coupled to the warning member 230, wherein when the magnetically-activated control element 214 does not sense the magnetic field produced by the magnetic element 212, the magnetically-activated control element 214 activates the warning member 230 to give off a warning signal which may be in the form of sound, light or combination thereof. On the other hand, when the magnetically-activated control element 214 senses the magnetic field produced by the magnetic element 212, the magnetically-activated control element 214 switches off the warning member 230. The provided warning device 200 further comprises a control member 220 electrically coupled to the magnetically-activated control element 214 and the warning member 230 for setting up the frequency at which the warning signals are given off and time interval between individual batches of the warning signals.

For instance, the control member 220 may set the warning member 230 to give off the warning signal at a specific frequency for a few seconds, and then shut off for another few seconds before giving off the subsequent batch of warning signals. The control member 220 may further comprise a sound recording member (not shown) electrically coupled to the control member 220 to provide a sound recording function, thereby allowing for customized warning signals.

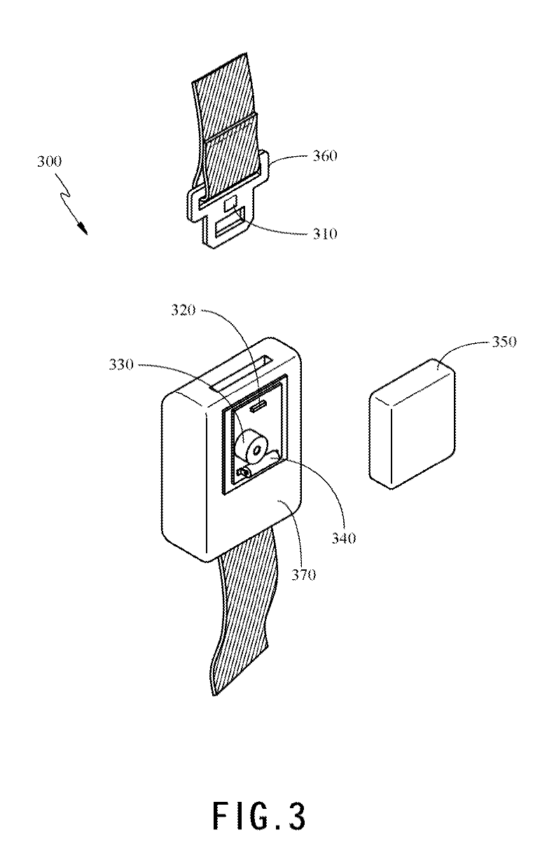

Referring to FIG. 3, it is an illustration of how the provided warning device 300 is used with a vehicle safety belt buckle set. As shown, in another preferred example of the above embodiment, the provided warning device 300 comprises a magnetic element 310 installed on a first buckle member 360 of the buckle set, and a magnetically-activated control element 320, a warning member 330, a power supply member 340 and a lid 350 installed on a second buckle member 370 of the buckle set. The power supply member 340 provides power to the provided warning device 300, and the lid 350 provides protection for the magnetically-activated control element 320, the warning member 330 and the power supply member 340.

When the first buckle member 360 and the second buckle member 370 are not engaged, the magnetically-activated control element 320 does not sense the magnetic field produced by the magnetic element 310, therefore the magnetically-activated control element 320 activates the warning member 330 to give off a warning signal which may being the form of sound, light or combination thereof. On the other hand, when the first buckle member 360 and second buckle member 370 are engaged, the magnetically-activated control element 320 senses the magnetic field produced by the magnetic element 310 and switches off the warning member 330.

There may be two magnetic elements 310 installed on opposite sides of the first buckle member 360 to ensure correct functioning of said warning device 300 regardless of how the first buckle member 360 engages the second buckle member 370.

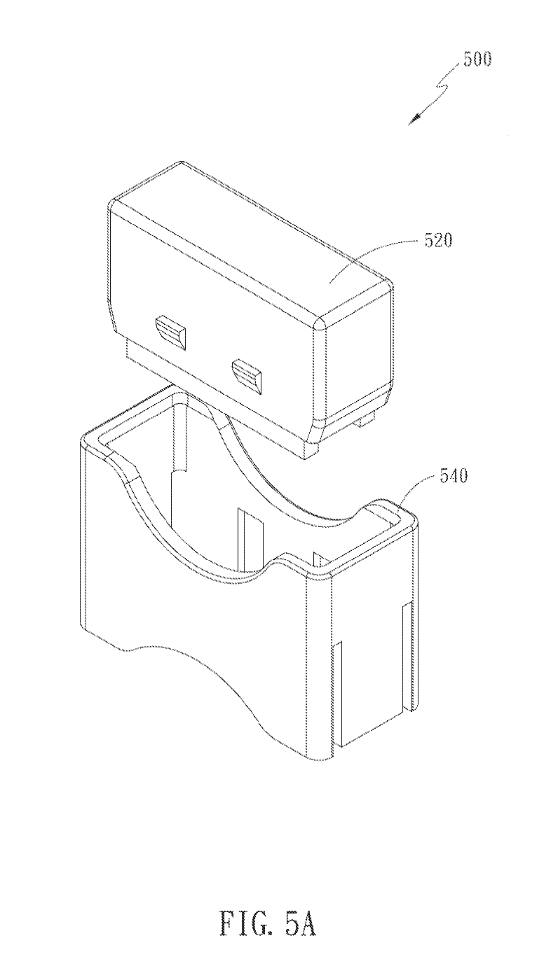

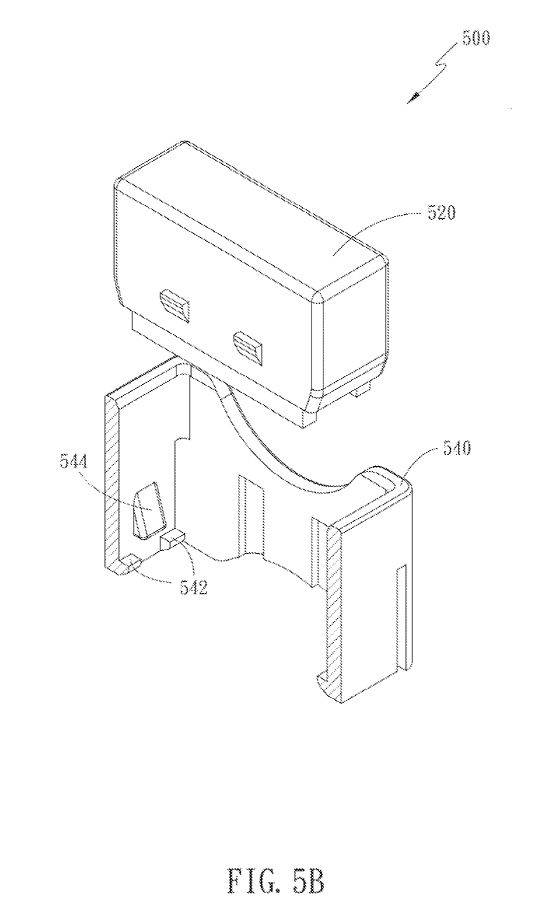

In one preferred example according to this embodiment, in order to properly put the magnetic element onto the accurate position of the first buckle member, the vehicle safety belt warning device can further comprises a clipper. Referred to FIG. 5A and FIG. 5B, the mentioned clipper 500 comprises a propelling part 520, and a clipping part 540. The propelling part 520 can be positioned into the mentioned clipping part 540. The mentioned magnetic element 310 can be clipped by the clipping part 540. When the propelling part 520 is put into the clipping part 540 and triggering the mechanical design therein, the clipping part 540 will release the magnetic element 310 and the magnetic element 310 will be attracted by the first buckle member 360 and moving to the desired position.

As shown in FIG. 5B, according to the mentioned example, two opposite walls of the clipping part 540 have movable parts, and each of the movable parts are at the lower portion of the mentioned opposite walls. The clipping part 540 comprises a plurality of claw elements 542 and stoppers 544. Referred to FIG. 5B, in one preferred example, the opposite edges of each movable parts have an interstice, so that each of the movable parts is moved potentially. The claw elements 542 and the stoppers 544 are at the mentioned movable parts of the opposite walls, and the stoppers 544 are above the claw elements 542. Each of the stoppers 544 comprises an inclined plane. The mentioned claw elements 542 are near the terminal of the movable parts. The magnetic element 310 is clipped between the claw elements 542 and the stoppers 544.

After clipping the magnetic element 310 between the claw elements 542 and the stoppers 544, the clipping part 540 can be moved over the desired position of the first buckle member 360. Before the propelling part 520 triggering the clipping part 540 to release the magnetic element 310, the magnetic element 310 will be kept in the clipping part 540. When the propelling part 520 is put into the clipping part 540, the opposite sides of the propelling part 520 corresponding to the sides of the clipping part 540 with the claw elements 542 and the stoppers 544 will push the sides of the clipping part 540 with the claw elements 542 and the stoppers 544 toward opposite direction by the stopper 544. So that the claw elements 542 will be moved outside and the magnetic element 310 will be released. And, the magnetic element 310 will automatically move down to the wanted position by the magnetic attraction between the first buckle member 360 and the magnetic element 310.

In another preferred example of this specification, the mentioned propelling part 520 can further comprise a plurality of protruding portions, and the clipping part 540 can further comprise a plurality of slide ways, wherein the slide ways are corresponding to the protruding portions on the propelling part 520. The mentioned slide ways are positioned at the internal side of the opposite two walls except the mentioned two opposite walls with movable parts. The mentioned protruding portions and the slide ways can be helpful for ensuring the propelling part 520 precisely triggering the claw elements 542 to release the magnetic element 310.

In still another preferred example of this specification, in order to enhance the contact between the magnetic element 310 and the first buckle member 360, the magnetic element 310 can further comprise an adhesive layer, not shown in the figures, at the side of the magnetic element 310 facing to the first buckle member 360. The mentioned adhesive layer is selected from adhesives, double sided tape(s), or others known by one skilled in the art.

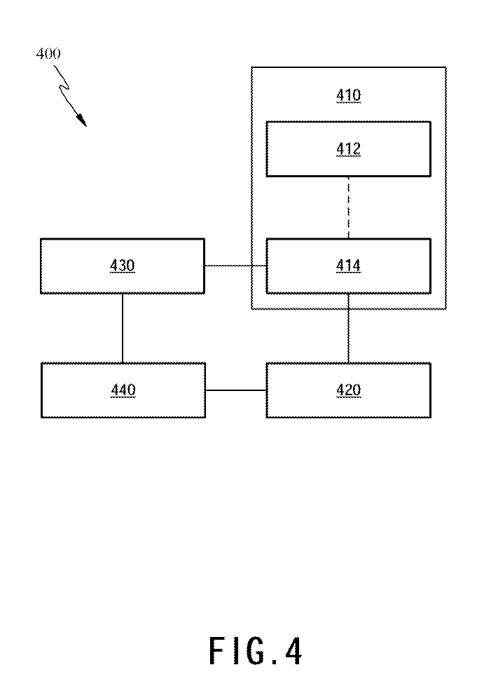

Referring to both FIG. 3 and FIG. 4, in yet another preferred example of the above embodiment, the provided warning device 400 comprises a sensing member 410, a warning member 420, and a power supply member 440. The provided warning device 400 further comprises a vibration sensing member 430 which is electrically coupled to the magnetically-activated control element 414 and the power supply member 440, such that when the first buckle member 360 and the second buckle member 370 are not engaged and the second buckle member 370 is shaken due to movement of the vehicle, the vibration sensing member 430 activates, through the magnetically-activated control element 414, the warning member 420 to give off the warning signal.

On the other hand, when the first buckle member 360 and second buckle member 370 are engaged, the magnetically-activated control element 414 senses the magnetic field produced by the magnetic element 412 and switches off the warning member. In such case, the warning member 420 is not activated if the second buckle member 370 is shaken.

The vibration sensing member 430 is selected from or any combination of the following: at least one ball-rolling switch, at least one spring vibration switch, at least one mercury vibration switch, and any other vibration sensing devices known to those skilled in the art.

In yet another preferred example of the above embodiment, a vehicle safety belt warning device is disclosed, the provided warning device comprises a first magnetic element which is installed on the vehicle door; a second magnetic element which is disposed within the interior of the vehicle and in a position corresponding to the first magnetic element; a warning member which is electrically coupled to the second magnetic element; and a power supply member which is electrically coupled to the warning member, for providing power to the provided warning device.

Either the first and second magnetic element may be a magnetically-activated control device. When the vehicle door is closed, the magnetically-activated control device senses the magnetic field produced by the magnetic element and activates the warning member to give off a warning signal which may being the form of sound, light or combination thereof.

The warning device may further comprise a control member electrically coupled to the magnetically-activated control device and the warning member for setting up the frequency at which the warning signals are given off and time interval between individual batches of the warning signals. The control member may further comprise a sound recording member electrically coupled to the control member to provide a sound recording function, thereby allowing for customized warning signals.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A vehicle safety belt warning device to be used with a vehicle safety belt buckle set which comprises a first buckle member and a second buckle member for engaging with the first buckle member to restrain an occupant in a vehicle for safety purpose, comprising:
a sensing member, comprising a magnetic element installed on said first buckle member by adhesives or double sided tape(s), and a magnetically-activated control element installed on said second buckle member by adhesives or double sided tape(s);
a warning member, electrically coupled to said magnetically-activated control element;
a power supply member, electrically coupled to said warning member, for providing power to said warning device; and
a clipper, wherein said magnetic element is put onto an accurate position of said first buckle member by said clipper, wherein said clipper comprises a propelling part and a clipping part, wherein the propelling part is able to be positioned into the clipping part and the magnetic element is clipped in the clipping part before the magnetic element mounted onto the first buckle member;
when said first buckle member and said second buckle member are not engaged, said magnetically-activated control element does not sense the magnetic field produced by said magnetic element and said magnetically-activated control element activates the warning member to give off a warning signal; and when said first buckle member and said second buckle member are engaged, said magnetically-activated control element senses the magnetic field produced by said magnetic element and switches off said warning member.

2. The warning device according to claim 1, wherein said sensing member comprises two magnetic elements installed on opposite sides of the first buckle member to ensure correct functioning of said warning device regardless of how said first buckle member engages said second buckle member.

3. The vehicle safety belt warning device according to claim 1, wherein said magnetic element is a thin magnet.

4. The vehicle safety belt warning device according to claim 1, further comprising a control member, electrically coupled to said magnetically-activated control element and said warning member, for setting up the frequency at which said warning signals are given off and time interval between individual batches of said warning signals.

5. The vehicle safety belt warning device according to claim 4, further comprising a sound recording member, wherein said sound recording member is electrically coupled to said control member.

6. The vehicle safety belt warning device according to claim 1, wherein said warning signal is in the form of sound, light, or combination thereof.

7. The vehicle safety belt warning device according to claim 1, wherein the clipping part of the clipper comprises a plurality of claw elements and stoppers therein, wherein the claw elements and the stoppers are at two opposite side walls respectively with a movable part at the lower portion of the clipping part, wherein the stoppers are respectively positioned above the claw elements, wherein the magnetic element is positioned between the claw elements and the stoppers when the magnetic element is clipped by the clipper.

8. The vehicle safety belt warning device according to claim 7, wherein the clipping part further comprises a plurality of slide ways at the internal side of the opposite two walls of the clipping part without the movable parts, wherein the propelling part further comprises a plurality of protruding portions respectively corresponding to the slide ways.

9. A vehicle safety belt warning device, comprising:
a first magnetic element, installed on the vehicle door by adhesives or double sided tape(s);
a second magnetic element, disposed within the interior of the vehicle by adhesives or double sided tape(s) and in a position corresponding to said first magnetic element;
a warning member, electrically coupled to said second magnetic element;
a power supply member which is electrically coupled to said warning member, for providing power to said warning device; and
a clipper, wherein said first magnetic element/said second magnetic element is put onto an accurate position of the vehicle door/within the interior of the vehicle by said clipper, wherein said clipper comprises a propelling part and a clipping part, wherein the propelling part is able to be positioned into the clipping part and the magnetic element is clipped in the clipping part before said first magnetic element/said second magnetic element mounted onto the vehicle door/within the interior of the vehicle;
when the vehicle door is closed, said second magnetic element senses the magnetic field produced by said first magnetic element and activates said warning member to give off a warning signal.

10. The vehicle safety belt warning device according to claim 9, wherein said first magnetic element is a magnetically-activated control device.

11. The vehicle safety belt warning device according to claim 9, wherein said second magnetic element is a magnetically-activated control device.

12. The vehicle safety belt warning device according to claim 10, further comprising a control member, electrically coupled to said magnetically-activated control device and said warning member, for setting up the frequency at which said warning signals are given off and time interval between individual batches of said warning signals.

13. The vehicle safety belt warning device according to claim 11, further comprising a control member, electrically coupled to said magnetically-activated control device and said warning member, for setting up the frequency at which said warning signals are given off and time interval between individual batches of said warning signals.

14. The vehicle safety belt warning device according to claim 9, wherein said warning signal is in the form of sound, light, or combination thereof.

15. The vehicle safety belt warning device according to claim 9, wherein the clipping part of the clipper comprises a plurality of claw elements and stoppers therein, wherein the claw elements and the stoppers are at two opposite side walls respectively with a movable part at the lower portion of the clipping part, wherein the stoppers are respectively positioned above the claw elements, wherein the magnetic element is positioned between the claw elements and the stoppers when the first magnetic element/second magnetic element is clipped by the clipper.

16. The vehicle safety belt warning device according to claim 15, wherein the clipping part further comprises a plurality of slide ways at the internal side of the opposite two walls of the clipping part without the movable parts, wherein the propelling part further comprises a plurality of protruding portions respectively corresponding to the slide ways.
